(19) United States
(12) Patent Application Publication
(10) Pub. No.: US 2024/0349863 A1
(43) Pub. Date: Oct. 24, 2024

(54) HAIR DRYER

(71) Applicant: LG ELECTRONICS INC., Seoul (KR)

(72) Inventors: Sunggi KIM, Seoul (KR); Byungjik KIM, Seoul (KR); Eunji HWANG, Seoul (KR); Hyunjoo OH, Seoul (KR); Jisu HWANG, Seoul (KR)

(73) Assignee: LG ELECTRONICS INC., Seoul (KR)

(21) Appl. No.: 18/685,112

(22) PCT Filed: Aug. 30, 2021
(86) PCT No.: PCT/KR2021/011586

§ 371 Date: Feb. 20, 2024

(30) Foreign Application Priority Data
Aug. 26, 2021 (KR) 10-2021-0112980

(51) Int. Cl. A45D 20/12

(52) U.S. Cl. CPC A45D 20/12

(57) ABSTRACT

Provided may be a hair dryer comprising: a main body part including a gas outlet part; a handle extending downwardly from the main body part and including a handle case and an air inlet part; an airflow path extending from the air inlet part to the gas outlet part through which gas flows; a fan unit provided inside the handle and flowing gas; and a battery module provided inside the handle and disposed on the airflow path, wherein the battery module is located below the fan unit, the airflow path includes a lower passage formed by a space spaced apart between the handle case and the battery module, and the air inlet part is formed at a position corresponding to the lower passage, such that the hair dryer can safely and efficiently arrange the fan unit and the battery module inside the handle.

### TECHNICAL FIELD

The present disclosure relates to a hair dryer, and more particularly to a hair dryer that can be used both wired and wirelessly.

### BACKGROUND ART

When a desired amount of moisture is removed from human hair in wet condition or human hair is styled into a desired shape from a current shape, a hair dryer that discharges gas through an air outlet is available.

A fan unit and the like may be installed in a hair dryer to make a gas flow. Thus, a hair dryer including such internal configuration may be designed in consideration of its own weight and the like to be conveniently used by a user.

In particular, in order to use the hair dryer wirelessly, a battery must be built in the hair dryer, and additional space must be secured to mount the battery in the hair dryer.

Since the hair dryer needs to rotate fans at high speed and instantaneously increase the temperature of air, heat generated from the battery may be problematic because the hair dryer consumes a lot of power.

According to a conventional hair dryer disclosed in Korean Patent Laid-Open Publication No. 2019-0084800 A1, an airflow path is formed in such a way that air introduced from a rear surface of a main body of the hair dryer moves in a straight direction and is discharged toward a front surface of the hair dryer. However, in the case of a wired hair dryer, a space for battery installation is not considered.

According to a conventional hair dryer of PCT Patent Publication No. 2019-094064, a battery is built in a lower portion of a handle of the hair dryer, but the hair dryer does not include a structure for discharging heat generated from the battery to the outside.

According to a conventional hair dryer of Korean Patent Registration No. 2170309, a battery is built in a main body of the hair dryer so as to be placed on an airflow path, but there is a problem in that a head becomes too large and heavy.

In implementing a wireless hair dryer, the position of battery installation should be provided in the hair dryer and a structure for battery cooling is required, such that an improved structure that can secure sufficient air current strength and sufficient temperature required for such battery cooling using a voltage lower than that of a wired hair dryer is needed.

### DISCLOSURE

### Technical Problem

An object of the present disclosure is to provide a hair dryer that can facilitate stable and easy installation of a fan unit and a battery inside a handle thereof.

Another object of the present disclosure is to provide a hair dryer with a structure that utilizes air introduced to discharge heat generated from a battery disposed in the handle.

Another object of the present disclosure is to provide a hair dryer that can minimize reduction of air current power on a changed airflow path.

Another object of the present disclosure is to provide a hair dryer that can obtain sufficient performance from a low-voltage battery so as to be used wirelessly.

Another object of the present disclosure is to provide a hair dryer with a heating structure that can be used both wirelessly and wired.

### Technical Solutions

In accordance with an aspect of the present disclosure, a hair dryer may include: a main body including an air outlet through which air is discharged outside: a handle formed to extend downward from the main body and configured to include a handle case forming an outer appearance of the handle and an air inlet through which air is introduced from the outside: an airflow path formed to extend from the air inlet to the air outlet so as to allow the air to flow therethrough: a fan unit provided inside the handle and disposed on the airflow path so as to allow air to flow from the air inlet to the air outlet: and a battery module provided inside the handle and disposed on the airflow path. The battery module is located lower than the fan unit: the airflow path may include a lower passage in which a separation space is formed between the handle case and the battery module: and the air inlet is formed at a position corresponding to the lower passage.

The handle may include: a handle case configured to form an outer appearance of the handle: and a separation space formed between the handle case and the battery module, wherein the separation space forms the lower passage.

The battery module may include a protrusion contacting an inner surface of the handle case: and the separation space is partitioned by the protrusion and divided into a plurality of spaces.

The battery module may include a plurality of column-shaped battery cells extending in a longitudinal direction of the handle: and the lower passage is disposed between the plurality of battery cells.

The hair dryer may further include: a battery case configured to surround the battery cells along an outer circumferential surface of the plurality of battery cells, wherein a surface of the battery case is provided with a plurality of uneven surfaces or a plurality of heat dissipation holes.

The battery module nay further include: a battery substrate connected to the plurality of battery cells on an upper surface thereof, wherein the battery substrate is configured not to overlap the lower passage.

The fan unit may include a high-speed rotation motor configured to operate at a high speed of more than 100,000 rpm.

The hair dryer may further include: a boosting module configured to increase a voltage when power is supplied from the battery module.

The airflow path may include: an upper passage configured to pass through the fan unit: and a pressure compensation passage disposed between the battery module and the fan unit by connecting the lower passage and the upper passage to each other.

The hair dryer may further include: a fan-unit seating unit configured such that the fan unit is seated in an upper portion of the battery module, wherein the pressure compensation passage is defined as a space between a top surface of the battery module and the fan-unit seating unit.

The fan-unit seating unit may include: a donut-shaped support unit formed with an opening corresponding to a suction portion of the fan unit: and at least one fixing leg extending from the support unit and coupled to the battery module, wherein the fixing leg has a height corresponding to a height of the pressure compensation passage.

The battery module may include a protrusion contacting an inner surface of the handle case, and the fixing leg may be coupled to the protrusion of the battery module.

The pressure compensation passage may have a larger cross-sectional area than a cross-sectional area of the lower passage and a cross-sectional area of a suction portion of the fan unit.

The hair dryer may further include: a power terminal configured to supply power to the battery module: and a controller configured to switch from a direct current (DC) mode to an alternating current (AC) mode when power is supplied to the power terminal.

The hair dryer may further include: a DC heater and an AC heater mounted in the main body, wherein the controller supplies power to the DC heater in the DC mode and supplies power to the AC heater in the AC mode.

The AC heater may include a coil heating wire having a small cross-sectional area and wound in a coil shape.

The DC heater may include a ribbon heating wire that has a larger cross-sectional area and a larger surface area than the coil heating wire while being arranged in a zigzag shape.

### Advantageous Effects

As is apparent from the above description, the hair dryer according to the embodiments of the present disclosure facilitates stable and easy installation of a fan unit and a battery inside a handle thereof.

The hair dryer according to the embodiments of the present disclosure can increase efficiency by utilizing heat generated by a battery module, and can discharge heat generated from the battery module without a separate cooling unit.

The hair dryer according to the embodiments of the present disclosure can constitute an airflow path to prevent reduction of a gas flow rate, so that the operation efficiency of the hair dryer can be increased.

Additionally, the hair dryer according to the embodiments of the present disclosure can be used both wirelessly and wired, so that usability of the hair dryer can be increased.

Further, embodiments of the present disclosure may provide a hair dryer capable of effectively reducing vibration and noise generated by a fan unit.

Further, embodiments of the present disclosure may provide a hair dryer capable of efficiently disposing a fan unit within a handle stably and efficiently.

### DESCRIPTION OF DRAWINGS

FIG. 1 is a schematic diagram of a hair dryer according to an embodiment of the present disclosure.

FIG. 2 is a cross-sectional view illustrating the interior of a hair dryer according to an embodiment of the present disclosure.

FIG. 3 is an exploded perspective view illustrating a hair dryer according to an embodiment of the present disclosure.

FIG. 4 is a cross-sectional view illustrating various examples of arrangement of the battery built in a handle of the hair dryer according to an embodiment of the present disclosure.

FIG. 5 is a perspective view illustrating a battery module of the hair dryer according to an embodiment of the present disclosure.

FIG. 6 is a diagram illustrating an airflow path of the hair dryer according to an embodiment of the present disclosure.

FIG. 7 is a perspective view illustrating a temperature control unit of the hair dryer according to an embodiment of the present disclosure.

FIG. 8 is a side view and a side cross-sectional view illustrating the temperature control unit of the hair dryer according to an embodiment of the present disclosure.

FIG. 9 is a diagram showing an alternating current (AC) heater and a direct current (DC) heater of the temperature control unit of the hair dryer according to an embodiment of the present disclosure.

### BEST MODE

Reference will now be made to embodiments, examples of which are illustrated in the accompanying drawings, to facilitate those having ordinary skill in the art to implement the embodiments. Embodiments may be implemented in various kinds of different types and non-limited by the embodiments described herein. Wherever possible, the same or like reference numbers have been used throughout the drawings to refer to the same or like components and repetitive description of the same components has been omitted.

The present disclosure may be implemented in various kinds of different types and non-limited by the embodiments described herein. Wherever possible, the same reference numbers will be used throughout the drawings to refer to the same or like parts.

In the present specification, redundant description of the same components will be omitted.

In the present specification, if one component is mentioned as ‘connected to’ or ‘accessing’ another component, the former component may be connected to accesses the latter component in direct. Yet, it is understood that a different component may be present in-between. On the other hand, if one component is mentioned as ‘directly connected to’ or ‘directly accessing’ another component, it is understood that a different component may is not present in-between.

Terms used in the present specification are used to describe a specific embodiment only but have no intention to limit embodiments

In the present specification, singular expression may include plural expressions unless having a clear meaning in the context.

In the present application, such a terminology as ‘include’, ‘have’ and the like intends to designate that a feature, a number, a step, an operation, a component, a part or a combination thereof disclosed in the specification exists and should be understood as not excluding possibility of existence or addition of at least one or more features, numbers, steps, operations, components, parts or combinations thereof.

In addition, in the present specification, the term ‘and/or’ includes a combination of a plurality of disclosed entries or a prescribed one of a plurality of the disclosed entries. In the present specification, ‘A or B’ may include ‘A’, ‘B’, or ‘both A and B’.

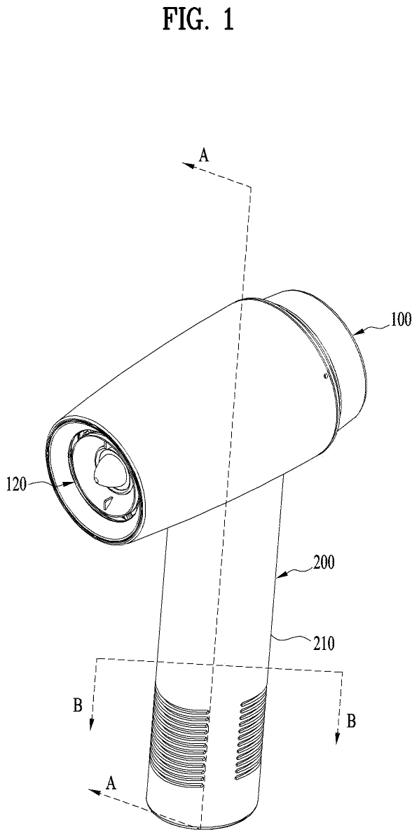

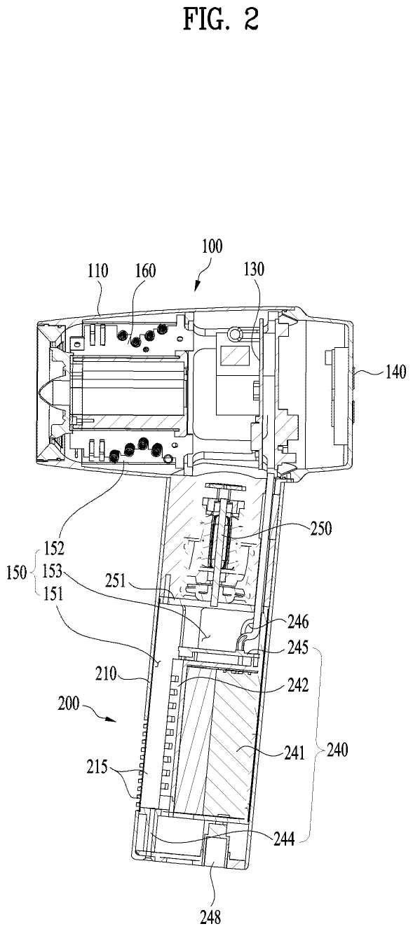

FIG. 1 is a schematic diagram of a hair dryer according to one embodiment of the present disclosure, and FIG. 2 is a cross-sectional diagram showing the inside of the hair dryer shown in FIG. 1.

As shown in FIG. 1, a hair dryer according to one embodiment of the present disclosure includes a main body 100 and a handle 200. And, the main body 100 includes an air outlet 120 through which a gas flowing in from an outside is discharged.

The main body 100, as shown in FIG. 2, may include an airflow path 150 formed therein so that a gas can flow therein. And, the airflow path 150 may be configured to extend from the handle 200 into the main body 100.

The airflow path 150 may be formed by the inside of the main body 100 and the inside of the handle 200 and defined as an area extending from an air inlet 215 to the air outlet 120. The main body 100 may include the air outlet 120 through which a gas flowing along the airflow path 150 is discharged externally. The main body 100 may have a shape that extends side by side with a gas discharged direction of the air outlet 120, and may be configured to have various cross-sectional shapes such as a circle, a polygon, etc.

A gas flowing in the main body 100 is sucked in through the air inlet 215 that may be provided to the main body 100 or the handle 200. As shown in FIG. 1 and FIG. 2, when the air inlet 215 is provided to the handle 200, the airflow path 150 may be configured in a manner of extending from the handle 200 to the main body 10, and more particularly, from the air inlet 215 to the air outlet 120.

A gas is sucked in from outside through the air inlet 215 provided to the main body 100 or the handle 200. The sucked-in gas flows along the airflow path 150 and may be discharged externally through the air outlet 120 provided to the main body 100.

The handle 200 may be extended from the main body 100. Referring to FIG. 1 and FIG. 2, the handle 200 is approximately extended from the main body 100 in a bottom direction.

The handle 200 may have a shape extended from the main body 100. The handle 200 may be integrally formed with the main body 100. Alternatively, the handle 200 may be separately manufactured and then coupled to the main body 100.

If the handle 200 is separately manufactured and then coupled to the main body 100, it may be configured to have a fixed or variable longitudinal direction to the main body 100.

For example, the handle 200 has a hinge coupling part and may be configured to be variable in a longitudinal direction of the handle 200, i.e., to be foldable to the main body 100 by being coupled to the main body 100.

The handle 200 may become a region held with a hand by a user, thereby having a shape to improve the ease of grip. An extended direction of the handle 200 may be various. For clarity of the following description, a direction in which the handle 200 is extended from the main body 100 will be described as a bottom direction.

Namely, in the present disclosure, top and bottom directions may be defined with reference to the handle 200. For example, the handle 200 may have a shape extended from the main body 100 in a bottom direction, and the main body 100 may be located in a top direction.

Therefore, in the present disclosure, a vertical direction is not necessarily to be understood as a direction perpendicular to the ground, but includes an obliquely inclined shape as shown in FIG. 2. For convenience of explanation, the vertical direction may be defined as a longitudinal direction with respect to the handle 200.

Referring to FIG. 2, the hair dryer according to one embodiment of the present disclosure includes a fan unit 250 capable of forcing a gas to flow and adjusting a speed of a discharged gas discharged through the air outlet 120. The fan unit 250 is disposed on the airflow path 150 to force the gas to flow and may be provided within the main body 100 or the handle 200.

For example, if the air inlet 215 is disposed in the handle 200, the airflow path 150 may extend from the air inlet 215 to the air outlet 120 of the main body 100 and the fan unit 250 may be disposed on the airflow path 150 located in the handle 200.

The hair dryer may include a battery module 240 so that the hair dryer can be used wirelessly. When the battery module 240 is disposed in the main body 100, a total weight of the hair dryer unavoidably increases and usability and convenience of the hair dryer may decrease, so that the battery module 240 may be disposed in the handle 200 as shown in FIG. 2. Since the weight of the battery module 240 is greater than the fan unit 250 disposed in the handle 200, the battery module 240 may be located at a lower portion of the handle 200 and the fan unit 250 may be located in an upper portion of the handle 200.

A temperature control unit 160 configured to control a temperature of a discharged gas may be provided within the main body 100. The temperature control unit 120 may be configured in various forms and provided to various locations. The temperature control unit 160 provided within the main body 100 is schematically shown in FIG. 2.

In addition, various types of the temperature control unit 160 may be prepared. For example, the temperature control unit 160 may heat a gas by generating heat in a manner of applying a current to a resistor of a coil type.

Yet, the resistor of the temperature control unit 160 may not be a coil type. For example, a gas may be heated using a thermoelement or the like. Thus, various types of controlling a temperature of a gas can be employed.

An operating system of a hair dryer according to one embodiment of the present disclosure is schematically described together with a gas flow as follows.

First of all, a user may manipulate a power button disposed on the main body 100 or the handle 200. Once the power button is turned on, the fan unit 250 is activated so that a gas flows into the hair dryer through the air inlet 215.

The gas flowing in through the air inlet 215 is forced to flow along the airflow path 150 by the fan unit 250 toward the air outlet 120. Hence, the discharged gas is discharged from the air outlet 120, thereby being provided to the user.

In doing so, the gas on the airflow path 150 may have a flowing speed controllable by the fan unit 250 and a temperature may be controlled by the temperature control unit 160.

In some implementations, the hair dryer according to one embodiment of the present disclosure may include a controller. The controller may be configured to control the components in a manner of being connected to the fan unit 250, the temperature control unit 160, the power button, the manipulating part and the like.

The operating state control by the fan unit 250 and the temperature control unit 160 may be performed in a manner that the user manipulates the manipulating part, or may be automatically performed according to an operation mode preset for the controller.

The air inlet 215 may include a plurality of air inlet holes penetrating a handle case 210. The airflow path 150 may extend from the air inlet 215 to the air outlet 120 so that air flows along the airflow path 150.

The airflow path 150 may include a second airflow path 155 that is located in the main body 100 to allow air to flow in the horizontal direction, and first airflow paths (151, 152, 153) that are located in the handle 200 to extend in the longitudinal direction of the handle 200.

The air inlet 215 may be located at a lower portion of the handle 200, and the air outlet 120 may be located at the end opposite to a portion to which the handle 200 of the main body 100 is coupled. The airflow path 150 may include pressure compensation passages (153, 154) to prevent a flow rate from decreasing in a portion where the first airflow paths (151, 152, 153) and the second airflow paths (154, 155) are arranged in a ┐-shape and the airflow path 150 is bent. The pressure compensation passages (153, 154) are characterized in that they contain a space of a sufficient size or have a gentle slope so that the airflow direction is changed.

Since a lot of space is required to form an airflow path having a gentle slope, the pressure compensation passages (153, 154) according to the embodiment are designed to have a large space.

The fan unit 250 may be provided within the handle 200 so as to force a gas having flown into the handle 200 to flow toward the air outlet 120. The fan unit 250 may be disposed on the airflow path 150 so as to force a gas to flow.

Whereas a conventional hair dryer includes a fan unit 250 placed in the main body 100 so that the fan unit 250 has a relatively large fan, the fan unit 250 according to this embodiment is disposed in the handle 200 and a diameter of the handle 200 is smaller than that of the main body 100 so that the fan unit 250 becomes smaller in size.

Since the fan of the fan unit 250 is reduced in size, a rotation speed (e.g., rpm) of a motor may increase so that the motor rotates at a high speed and generates a flow of air in the airflow path 150. For example, the fan unit 250 running at 100,000 rpm can generate sufficient air current speed even if the fan size is small.

In particular, when the hair dryer is driven using the battery module 240, the hair dryer may have a lower voltage than the other case in which the hair dryer is directly connected to a power source by wire. Alternatively, when the hair dryer is used wirelessly, the battery module 240 may use direct current (DC) power of a voltage of about 10V, and when the hair dryer is used by wire, the hair dryer may use AC power of a voltage of about 215V. When driving the fan unit 250 with low-voltage power of the battery module 240, the fan unit 250 can be driven by increasing the voltage using a boosting module that performs voltage boosting to obtain sufficient air current strength.

Since the battery module 240 emits heat, the heat may be cooled by placing the battery module 240) on the airflow path 150 through which gas flows. Since the battery module 240) is located in the handle 200, the battery module 240 may be disposed in the first airflow path located in the handle 200.

That is, the first airflow paths (151, 152, 153) may be further classified into a lower passage 151 and an upper passage 152. The lower passage 151 may include the battery module 240 while connecting to the air inlet 215, and the upper passage 152 may include the fan unit 250 while passing through the fan unit 250.

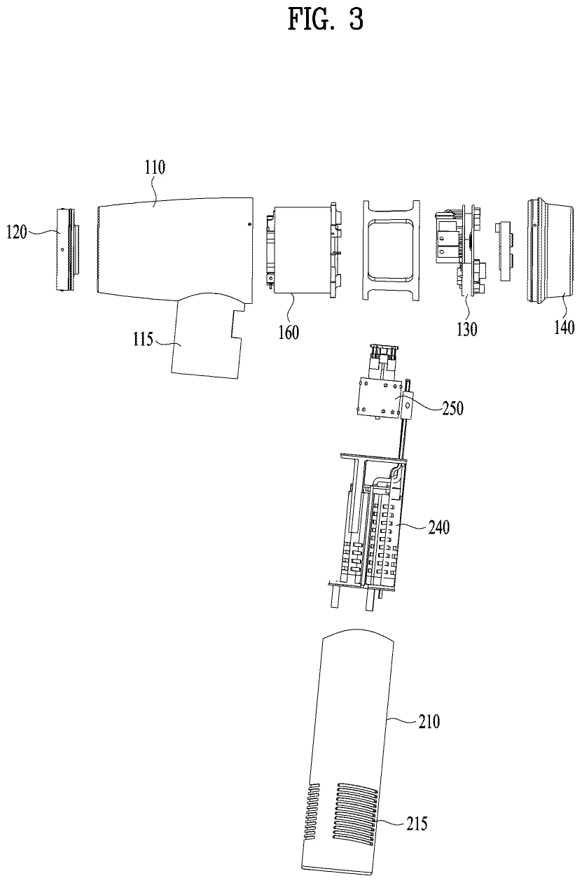

FIG. 3 is an exploded perspective view illustrating the hair dryer according to an embodiment of the present disclosure. Referring to FIG. 3, a main body case 110, an air outlet located at one side of the main body case 110, and a temperature control unit 160 built in the main body case 110 are illustrated. Here, the main body case 150 may allow electronic components to be fixed in the main body 100 and may increase rigidity of the main body 100, and a controller 130 is further illustrated in FIG. 3. As can be seen from FIG. 3, the main body case 110, the air outlet 120, the temperature control unit 160, a connection frame 115, and the controller 130 may constitute the main body 100.

Since the air inlet 215 of the present disclosure is not located at the other side of the main body 100, but is located at the handle 200, the controller 130 that can control the hair dryer and a user input unit 140 may be disposed at the other side of the main body 100.

Since the temperature control unit 160 that applies heat to the air is located at one side of the main body 100, the controller 130 and the user input unit 140 are located at the other side to prevent damage to components such as driving chips or liquid crystals due to heat.

As shown in FIG. 3, the main body case 110 may further include a connection frame 115 protruding toward the handle 200. The connection frame 115 may be integrated with the main body case 110 and may be inserted into the handle case 210.

As shown in FIG. 2, the fan unit 250 may be located at a position where the connection frame 115 is coupled. That is, the connection frame 115 may connect the handle 200 to the main body portion 100 at the same time as the fan unit 250 is mounted. The connection frame 115 according to this embodiment is shown as being connected to the main body case 110 and inserted into the handle case 210, but the connection frame 115 may also be fixed in the main body case 110 by extending from the handle case 210.

FIG. 3 shows the handle case 210 separated from the main body 100. The handle case 210 may form the airflow path 150, and may provide an internal space in which the battery module 240) and the fan unit 250 are mounted.

The handle case 210 may be divided into an upper portion and a lower portion, and the battery module 240 may be mounted in the lower portion of the handle case 210. The connection frame 115 may be inserted into the upper portion of the handle case 210, and the fan unit 250 may be disposed inside the connection frame 115. The battery module 240 may be implemented using a plurality of pillar-shaped battery cells 241, and the plurality of pillar-shaped battery cells 241 may be disposed to obtain a required voltage.

For performance (e.g., high-temperature and strong air current) of a wireless (cordless) hair dryer, it is preferable that the battery cell 241 have a larger size. However, as the battery module 240 increases in size, i.e., as the number of battery cells increases, the internal space required for installation of the battery module 240 and the fan unit 250 becomes smaller.

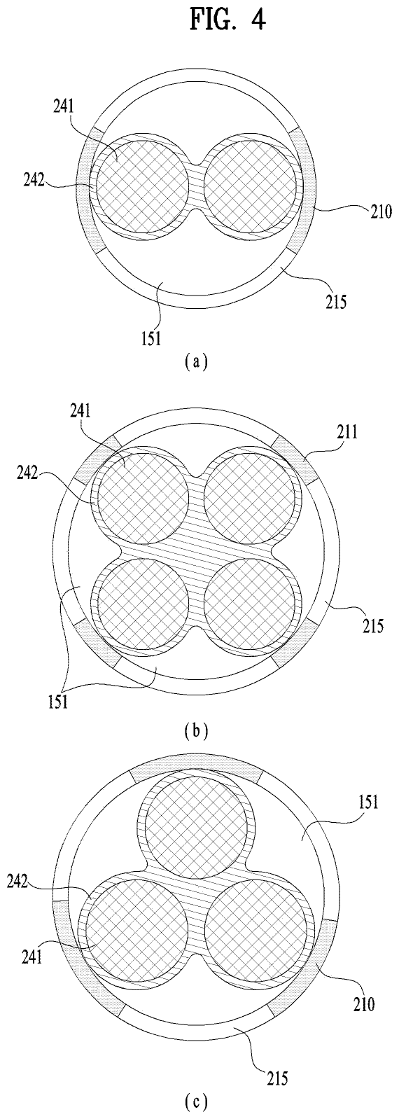

FIG. 4 is a diagram illustrating the arrangement of the battery module 240 according to the number of battery cells 241. FIG. 4(a) shows an embodiment including two battery cells 241, FIG. 4(b) shows an embodiment including four battery cells 241, and FIG. 4(c) shows an embodiment including three battery cells 241.

The battery cell 241 shown in FIG. 4 may be formed in a cylindrical shape, but in addition to the cylindrical shape, the battery cell 241 may also be formed in a hexagonal or octagonal pillar shape. When a plurality of cylindrical battery cells 241 is arranged, the interior of the cylindrical or elliptical column-shaped handle case 210 is not completely filled with the battery cells 241, so that a gap or space (separation space) is formed as shown in FIG. 4.

The airflow path 150 may be formed by utilizing the space between the battery module 240) and the handle case 210, and the airflow path 150 located in the space between the battery module 240) and the handle case 210 may be called a lower passage 151. The lower passage 151 is where external air is introduced through the air inlet 215 and passes therethrough for the first time. The shape and number of lower passages 151 may vary depending on the shape of the battery module 240.

When each of the battery cells 241 is formed in a cylindrical shape as shown in FIG. 4, the spaces between the battery cells 241 are spaced apart from each other, and a portion of the outer surfaces of the battery cells 241 may contact the inside of the handle case 210. The lower passage 151 may be partitioned at a place where the outer surface of each battery cell 241 and the inner surface of the handle case 210 come into contact with each other, thereby forming a plurality of lower passages 151.

When two battery cells 241 are used as in the embodiment of FIG. 4 a), the space between the battery module 240 and the handle case 210 is large, so that a large flow path can be formed. However, because the number of battery cells 241 is small, sufficient voltage required to drive the fan unit 250 and the temperature control unit 160 cannot be obtained.

When four battery cells 241 are used as in the embodiment of FIG. 4(b), a larger number of battery cells 241 can be mounted compared to a cross-sectional area of the handle case 210, but the area of the lower passage 151 becomes smaller and the handle 200 becomes larger so that a user cannot easily grasp the handle 200.

When three battery cells 241 are used as in the embodiment of FIG. 4(c), an appropriate number of battery cells 241 can be mounted compared to the cross-sectional area of the handle case 210 and a sufficient area for the lower passage 151 can also be secured, so that the handle 200 can be prevented from becoming too large.

The number and arrangement of the battery cells 241 can be configured differently depending on the size of the battery cell 241 and the voltage required to operate the fan unit 250. Hereinafter, for convenience of explanation, the following description will be given based on the battery module 240 composed of three battery cells 241.

The battery module may further a battery case 242 for packaging the battery cells 241. The battery case 242 may be formed to have a uniform thickness along the outer circumferential surface of the gathered battery cells 241, and may implement the lower passage 151 using a space between the battery cells 241.

An air inlet 215 may be formed to allow air to flow into the lower passage 151 located in the space between the handle case 210 and a concave portion formed between the battery cells 241. That is, the air inlet 215 may be formed in the handle case 210 of the lower passage 251, and a plurality of air inlets 215 may be formed in the longitudinal direction of the handle 200 as shown in FIG. 1.

Air passing through the lower passage 151 may absorb heat generated from the battery cell 241, so that the temperature of sucked air can increase and at the same time the battery cell 241 can be prevented from overheating.

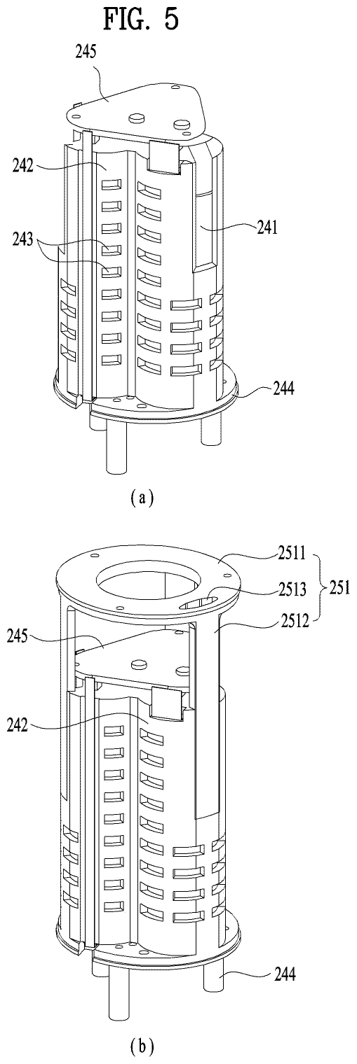

FIG. 5 is a perspective view illustrating the battery module 240 of the hair dryer according to an embodiment of the present disclosure, and the battery cells 241 may be mounted inside the battery case 242. The lower portion of the battery module 240 may include a support plate and support legs 244 that support the battery cells 241.

Referring to FIG. 2, the support legs 244 may prevent the battery cell 241 from sagging toward a charging terminal 248 located at a lower end of the handle 200. That is, a space where the charging terminal 248 can be located may be provided at the lower end of the battery cell 241 and the handle case 210.

The battery module 240 may be fixed to the handle case 210 by fastening the lower end of the support legs 244 and the handle case 210 with a screw or the like.

Uneven surfaces or heat dissipation holes 243 may be formed on the outer circumferential surface of the battery case 242 to effectively discharge heat generated by the battery cell 241. A contact area with air can be expanded through uneven surfaces or heat dissipation holes 243 of the battery case 242.

The space between the battery cells 241 is the lower passage 151, and a battery substrate 245 of the battery module 240 may have a shape corresponding to the arrangement of the battery cells 241 as shown in FIG. 5(a) so as not to interfere with the airflow path 150 connected to the upper passage 152.

That is, the battery substrate 245 is a substrate in which a protruding portion of the battery module 240 is formed. In this embodiment, three battery cells 241 are used, so that a triangular battery substrate 245 may be used. The battery substrate 245 may implement a desired voltage by connecting to battery cells 241, and may be connected to a power cable 246 that supplies power to the main substrate 140 mounted in the main body 100.

The battery substrate 245 may be disposed on the battery cell 241 so as not to protrude toward the lower passage 151, and a fan-unit-seating unit on which the fan unit 250 is seated may be coupled to the battery cell 241. FIG. 5(b) shows the fan-unit-seating-unit coupled to the upper portion of the battery unit of FIG. 5(a). The fan-unit-seating-unit may include fixed legs and a support unit that support the lower portion of the fan unit 250.

The support unit may be formed in a shape corresponding to the bottom surface of the fan unit 250, and may have a donut shape including an opening that has a size corresponding to an inlet of the upper passage 152 penetrating the fan unit 250. In order to secure the pressure compensation passage 153 between the fan unit 250 and the battery module 240, the support unit is disposed at a predetermined distance from the top of the battery module 240, and the distance between the support unit and the battery module 240 may be determined by the length of each of the support legs of the fan-unit-seating-unit.

The support leg 244 may extend downward from the support unit and may be coupled to the battery case 242. The support leg may be coupled to a protrusion of the battery module 240 so as not to interfere with the lower passage 151. Since there are three battery cells 241 in the hair dryer of this embodiment, three support legs of the fan-unit-seating unit can also be used in the hair dryer.

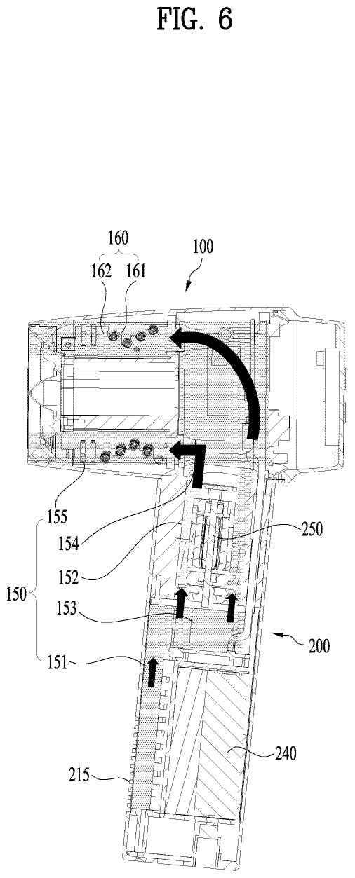

FIG. 6 is a diagram illustrating the airflow path 251 of the hair dryer according to an embodiment of the present disclosure. The first flow passages (151, 152, 153) located in the handle 200 may include a lower passage 151, an upper passage 152, and a pressure compensation passage 153 located between the lower passage 151 and the upper passage 152.

The lower passage 151 may be located along the circumference of the battery cell 241, and the upper passage 152 may pass through the fan motor, so that the positions of the lower passage 151 and the upper passage 152 are different. Therefore, when the lower passage 151 and the upper passage 152 are adjacent to each other, there is a problem that the speed decreases because a passage leading from the lower passage 151 to the upper passage 152 is bent by 90 degrees.

Accordingly, the pressure compensation passage 153 may be provided to secure sufficient space between the lower passage 151 and the upper passage 152 so that the direction of the passage from the lower passage 151 to the upper passage 152 has a gentle slope.

In addition, the lower passage 151 may be divided into the battery module 240 so that the lower passage 151 includes three outlets, and the upper passage 152 may be formed as a cylindrical passage formed along the circumference of the fan unit 250. That is, because the outlets of the lower passage 151 are different from the inlet of the upper passage 152 in terms of shape, position, and size, the upper passage and the lower passage cannot form a straight line.

The pressure compensation passage 153 having a cross-sectional area that can cover both the inlet of the upper passage 152 and the outlets of the lower passage 151 may be provided. The pressure compensation passage 153, which has a larger cross-sectional area than the upper passage 152 and the lower passage 151, does not impede the flow of air from the lower passage 151 to the upper passage 152.

The second airflow path 155 may be located in the main body 100, and air that has moved upward after passing through the fan unit 250 needs to be discharged while being switched to a lateral direction. When the airflow direction is changed as described above, a narrow flow path causes the flow rate to decrease, so that a compression compensation passage 154 may be provided to have a large space between the second airflow path 155 and the first airflow paths (151, 152, 153).

The air that has moved to the second airflow path 155 may move to the air outlet 120 and then pass through the temperature control unit 160. The temperature control unit 160 may include heating wires (161, 162), and air having passed through the heating wires (161, 162) may be heated by the heating wires (161, 162), so that a high-temperature air current can be discharged outside.

The second airflow path 155 leading from the pressure compensation passage 153 to the air outlet 120 may be formed in a cylindrical shape, and a cross-sectional area of the second airflow path becomes small. By reducing the cross-sectional area of the airflow path, the air current strength can be increased. The second airflow path 155 may be formed in a cylindrical shape to increase the area in contact with the coil of the temperature control unit 160 compared to the cross-sectional area of the airflow path.

A heater of the temperature control unit 160 may include heating wires (161, 162), and the heating wires must be spaced apart from each other by a predetermined distance so that the heating wires 161 and 162 do not contact each other. When the heating wires (161, 162) come into contact with each other, the heating wires (161, 162) may be short-circuited or overheated, thereby causing a fire.

The heating wires (161, 162), which are arranged in a circular or spiral shape along the cylindrical second airflow path 155, may come into contact with air passing through the second airflow path 155 over a large area while being arranged so as not to overlap each other.

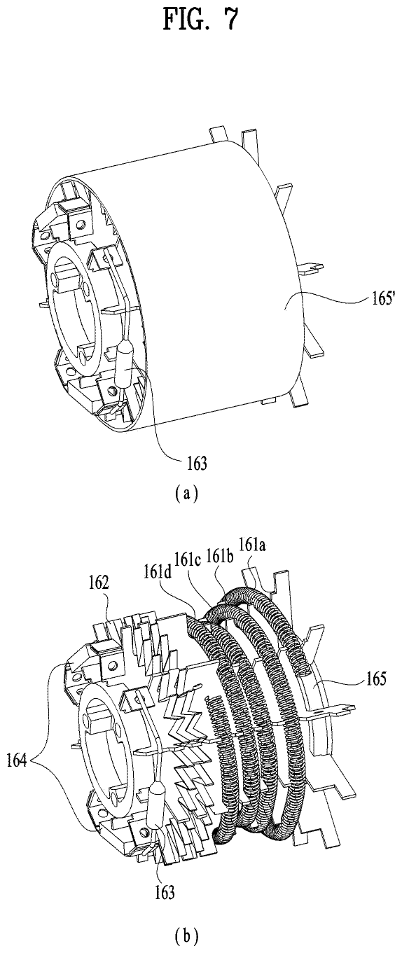

FIG. 7 is a perspective view illustrating the temperature control unit 160 of the hair dryer according to an embodiment of the present disclosure. FIG. 7(a) shows external appearance of the temperature control unit 160 covered with a cylindrical heater cover 165′, and FIG. 7(b) shows a view in which the heating wires are exposed by removing the heater cover 165′.

A ring-shaped second airflow path may be formed between the cylindrical heater housing and the heater cover having a larger diameter than the heater housing. A heater that receives power and generates heat may be provided between the ring-shaped second airflow paths.

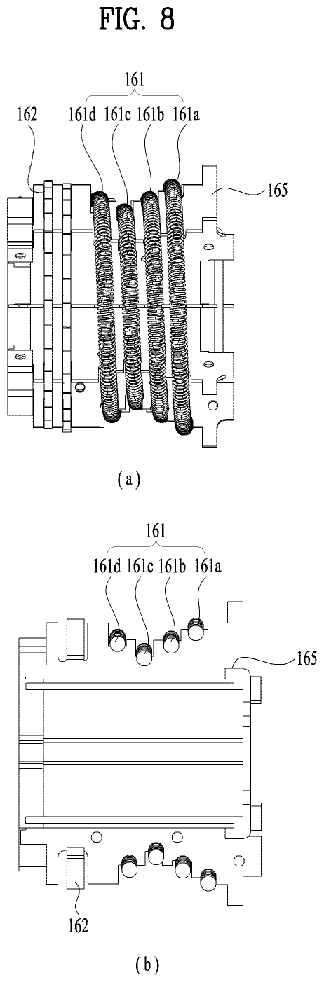

FIG. 8 is a side view and a side cross-sectional view illustrating the temperature control unit 160 of the hair dryer according to an embodiment of the present disclosure. FIG. 8 is a view illustrating an AC heater 161 and a DC heater 162 of the temperature control unit 160 of the hair dryer according to an embodiment of the present disclosure.

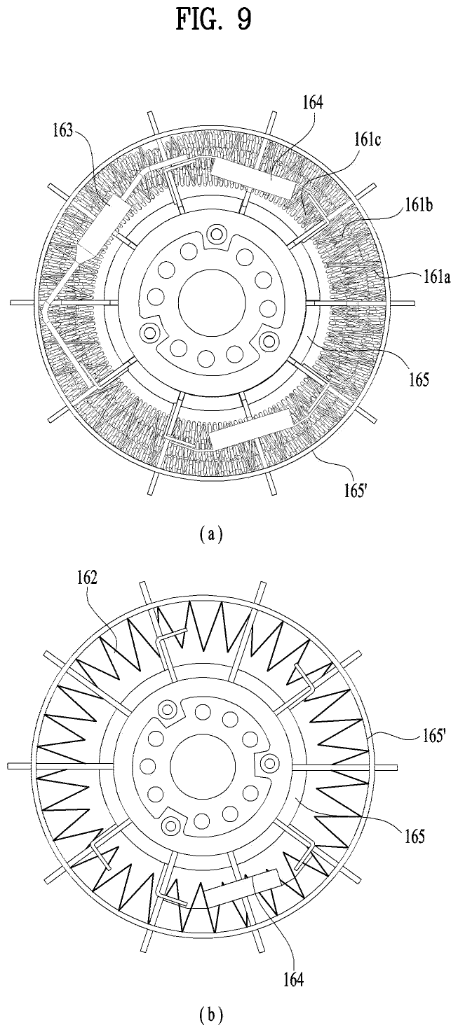

FIG. 8(a) is a side view of the temperature control unit 160, FIG. 8(b) is a side cross-sectional view of the temperature control unit 160, FIG. 9(a) shows the AC heater 161 viewed from the direction of the air outlet 120, and FIG. 9(b) shows the DC heater 162 viewed from the direction of the air outlet 120.

The hair dryer according to the present disclosure can be used both wired and wirelessly. Since the wired hair dryer is designed to use a high-voltage AC power source and the wireless hair dryer is designed to use a low-voltage DC power source, it is difficult to provide a heater that can operate both wired and wirelessly at the same time.

Therefore, the heaters according to the present disclosure may be classified into the AC heater 161 usable in a wired AC voltage environment and the DC heater 162 usable in a wireless DC voltage environment. Since the alternating current has a high voltage of 215V and the direct current has a low voltage of about 10V, the heating wires 161 and 162 should be used differently according to the wired and wireless environments.

The AC heater 161 is designed to receive a high-voltage power source as a power source. Thus, if resistance of the AC heater 162 is small, very high heat is generated, thereby causing the heating wires (161, 162) to burn out. Therefore, the AC heater 161 can be implemented using thin and long heating wires.

Meanwhile, the DC heater 162 operates at a low voltage of 10V. Thus, if resistance of the heating wire is too large, there is a problem in that no current flows in the DC heater and heat is not generated. Therefore, the DC heater 162 has a smaller resistance than the AC heater 161, so the DC heater 162 has a short length and a large thickness.

FIG. 8(a) is a diagram illustrating the temperature control unit 160 and shows the AC heater 161 and the DC heater 162 wound around a cylindrical heater housing 165. The AC heater 161 may use a coil heating wire formed in a first spiral shape, and this coil heating wire can be wound around the heater housing 165 while forming a second spiral shape.

The second airflow path 155 may be formed of a cylindrical space between the heater housing 165 and the heater cover 165′. If the space between the heater housing 165 and the heater cover 165′ is large, the airflow path becomes too large. If the space between the heater housing 165 and the heater cover 165′ is too small, the space required for heater installation is limited, so that the main body case 110 and the heater housing 165 can be arranged while being spaced apart from each other by an appropriate distance.

The AC heater 161 must use a long heating wire to increase resistance. Therefore, the coil heating wires may be wound multiple times along the circumference of the heater housing 165 to secure the heating wire of a sufficient length. When the coil heating wires are wound multiple times, they may be spaced apart from each other by a predetermined distance so that the coil heating wires (161a, 161b, 161c, 161d) may not overlap each other.

The heating wires (161a, 161b, 161c, 161d) constituting the second spiral may be designed to have different diameters, so that air can be in contact with the coil heating wire 161 with as large an area as possible when passing through the airflow path and can minimally affect the respective heating wires (161a, 161b, 161c, 161d) constituting the second spiral.

The diameter of the coil heating wire 161 becomes smaller as the coil heating wire 161 approaches the air outlet 120. Thus, air passing through the second airflow path 155 comes in contact with the coil heating wire 162 that was wound multiple times while forming a second spiral, and at the same time may move along the extension direction of the second airflow path.

In order to increase a contact area with air, it is desirable that the coil heating wire be arranged in a manner that the diameter of the second spiral becomes smaller, but there is a problem in that the second airflow path 155 has a larger width. Therefore, as shown in FIGS. 8(a) and 8(b), the last heating wire 161d may be wound around the heater housing 165 to form a circular shape having a larger diameter than the previous heating wire 161c.

In order to prevent the coil heating wires wound multiple times while forming the second spiral from contacting each other, it is necessary to distinguish each turn of the second spiral formed by the coil heating wires. As shown in FIG. 8(b), a groove may be formed in the heater housing 165 so that the coil heating wires can be disposed in the heater housing 165.

The DC heater 162 may use a lower voltage power source than the AC heater 161, so that a ribbon heating wire with a large cross-sectional area can be used. The ribbon heating wire 162 has a larger cross-sectional area and a shorter length than the coil heating wire 161, so that the ribbon heating wire 162 has a smaller resistance than the coil heating wire and can thus obtain a current that is not too small compared to a current flowing through the coil heating wire 161.

The DC heater 162 may be zigzagged along a cylindrical passage as shown in FIG. 9(b) so that the DC heater 162 can be in contact with the air passing through the second airflow path 155 over a large area as in the AC heater 161. As a result, the DC heater 162 may be placed in the second airflow path 155 while forming a star shape.

The length of the ribbon heating wire 162 may vary depending on the cross-sectional area of the ribbon heating wire 162, and two ribbon heating wires may be wound around the heater housing 165 once or twice or may provide sufficient heat while preventing resistance from excessively increasing.

The coil heating wire 161 constituting the AC heater 161 may be wound to form a first spiral and a second spiral, and may have a length several tens of times that of the DC heater 162, and the ribbon heating wire of the DC heater 162 may have a cross-sectional area several tens of times that of the coil heating wire of the AC heater 161.

Since the DC heater 162 operates at a lower voltage than the AC heater 161, heat generated by the DC heater 162 becomes less than that of the AC heater 161. In a wireless mode, the air current speed of the hair dryer is weakened to secure a maximum contact time during which the DC heater 162 can contact the air, so that the air current temperature can increase even in the wireless mode of the hair dryer.

The DC heater 162 is disposed closer to the air outlet 120 than the AC heater 161, so that the efficiency of the DC heater 162 operating at a relatively low temperature may be slightly improved.

Since there is a risk of fire if the temperature control unit 160 is overheated or short-circuited, the temperature control unit 160 may further include an overcurrent control device that blocks a current flowing in the heating wire. When the air of the second airflow path 155 has a temperature greater than or equal to a predetermined temperature, the overcurrent control device may cut off the power of the DC heater 162 or the AC heater 161 and may be placed closer to the air outlet 120.

The overcurrent control device may include at least one of a bimetal 164 and a fuse 163. The bimetal 164 refers to a device that blocks an electric current using thermal deformation of metals with different thermal conductivities, and the fuse 163 is blown when the wire connected to the heater has a temperature higher than a predetermined temperature.

When the overcurrent control device is implemented as the bimetal 164, a temperature of the bimetal 165 drops, and the bimetal 165 is reconnected to the heating wire of the heater. In contrast, when the overcurrent control device is implemented as the fuse 163, the fuse 163 must be replaced with a new one, so that an operating temperature of the fuse 163 may be set to a higher temperature.

In particular, the AC heater 161 designed to use a high-voltage power source may further include the fuse 163 as well as the bimetal 164 because there is a risk of fire due to occurrence of overheating or short-circuiting. In this embodiment, the DC heater 162 is shown to include only the bimetal 164 for convenience of description, but the DC heater 162 may further include the fuse 163.

The main body case 110, the heater housing 165, and the heater cover 165′ may include an insulating material with a low heat transfer rate. For example, the insulating material may include micanite.

The insulating material of the main body case 110 and the heater cover 165′ may prevent the user from getting burned by heat generated from the temperature control unit 160. In addition, since heat is not emitted to the outside, the temperature of the air passing through the second airflow path can increase and thermal efficiency can also increase.

Since the heater housing 165 is formed of the insulating material, the heater housing 165 can be prevented from being melted, deformed, or damaged due to heat of the heating wire.

Embodiments of the present disclosure can provide the hair dryer in which the fan unit and the battery module can be stably and efficiently installed in the handle.

The hair dryer according to the embodiments of the present disclosure can increase efficiency using heat generated by the battery module, and can discharge heat generated by the battery module to the outside without a separate cooling unit.

Additionally, the airflow path is configured so that the flow rate of air does not decrease, resulting in increased efficiency of the hair dryer.

Furthermore, usability of the hair dryer can be improved as the hair dryer can be used both wirelessly and wired simultaneously.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A hair dryer comprising:
a main body including an air outlet through which air is discharged outside:
a handle formed to extend downward from the main body and configured to include a handle case forming an outer appearance of the handle and an air inlet through which air is introduced from the outside;
an airflow path formed to extend from the air inlet to the air outlet so as to allow the air to flow therethrough:
a fan unit provided inside the handle and disposed on the airflow path so as to allow air to flow from the air inlet to the air outlet: and
a battery module provided inside the handle and disposed on the airflow path,
wherein
the battery module is located lower than the fan unit:
the airflow path includes a lower passage in which a separation space is formed between the handle case and the battery module; and
the air inlet is formed at a position corresponding to the lower passage.

2. The hair dryer according to claim 1, wherein the handle includes:
a handle case configured to form an outer appearance of the handle; and
a separation space formed between the handle case and the battery module,
wherein
the separation space forms the lower passage.

3. The hair dryer according to claim 2, wherein:
the battery module includes a protrusion contacting an inner surface of the handle case; and
the separation space is partitioned by the protrusion and divided into a plurality of spaces.

4. The hair dryer according to claim 3, wherein:
the battery module includes a plurality of column-shaped battery cells extending in a longitudinal direction of the handle: and
the lower passage is disposed between the plurality of battery cells.

5. The hair dryer according to claim 4, further comprising:
a battery case configured to surround the battery cells along an outer circumferential surface of the plurality of battery cells,
wherein a surface of the battery case is provided with a plurality of uneven surfaces or a plurality of heat dissipation holes.

6. The hair dryer according to claim 4, wherein the battery module further includes:
a battery substrate connected to the plurality of battery cells on an upper surface thereof,
wherein the battery substrate is configured not to overlap the lower passage.

7. The hair dryer according to claim 1, wherein the fan unit includes:
a high-speed rotation motor configured to operate at a high speed of more than 100,000 rpm.

8. The hair dryer according to claim 1, further comprising:
a boosting module configured to increase a voltage when power is supplied from the battery module.

9. The hair dryer according to claim 1, wherein the airflow path includes:
an upper passage configured to pass through the fan unit; and
a pressure compensation passage disposed between the battery module and the fan unit by connecting the lower passage and the upper passage to each other.

10. The hair dryer according to claim 9, further comprising:
a fan-unit seating unit configured such that the fan unit is seated in an upper portion of the battery module,
wherein
the pressure compensation passage is defined as a space between a top surface of the battery module and the fan-unit seating unit.

11. The hair dryer according to claim 10, wherein the fan-unit seating unit includes:
a donut-shaped support unit formed with an opening corresponding to a suction portion of the fan unit: and
at least one fixing leg extending from the support unit and coupled to the battery module,
wherein
the fixing leg has a height corresponding to a height of the pressure compensation passage.

12. The hair dryer according to claim 11, wherein:
the battery module includes a protrusion contacting an inner surface of the handle case: and
the fixing leg is coupled to the protrusion of the battery module.

13. The hair dryer according to claim 9, wherein:
the pressure compensation passage has a larger cross-sectional area than a cross-sectional area of the lower passage and a cross-sectional area of a suction portion of the fan unit.

14. The hair dryer according to claim 1, further comprising:
a power terminal configured to supply power to the battery module; and
a controller configured to switch from a direct current (DC) mode to an alternating current (AC) mode when power is supplied to the power terminal.

15. The hair dryer according to claim 14, further comprising:
a DC heater and an AC heater mounted in the main body,
wherein
the controller supplies power to the DC heater in the DC mode and supplies power to the AC heater in the AC mode.

16. The hair dryer according to claim 15, wherein:
the AC heater includes a coil heating wire having a small cross-sectional area and wound in a coil shape; and
the DC heater includes a ribbon heating wire that has a larger cross-sectional area and a larger surface area than the coil heating wire while being arranged in a zigzag shape.
